(19) United States
(12) Patent Application Publication
(10) Pub. No.: US 2026/0051307 A1
(43) Pub. Date: Feb. 19, 2026

(54) RECONFIGURABLE ACOUSTIC SURFACE USING MICROELECTROMECHANICAL SYSTEMS (MEMS) ACTUATORS FOR CHANGING CAVITY RESONANCE

(71) Applicant: Dell Products L.P., Round Rock, TX (US)

(72) Inventors: Tejinder Singh, Manotick (CA); Navjot Kaur Khaira, Manotick (CA)

(21) Appl. No.: 18/808,961

(22) Filed: Aug. 19, 2024

(51) Int. Cl. G10K 11/16

(52) U.S. Cl. CPC G10K 11/16

(57) ABSTRACT

The technology described herein is directed towards a metasurface arranged with unit cells for narrowband sound absorption, in which the unit cells are based on Helmholtz resonators that can have their resonant frequencies adjusted via MEMS actuators. A sound absorbing unit-cell is designed and constructed based on a general resonance frequency, and includes a neck portion and air chamber dimensioned to resonate close to the desired resonance frequency and thereby inverse phase cancel corresponding narrowband frequencies of incoming sound waves. A moveable partition in the resonators, controlled by MEMS actuators, facilitates changing of the resonators' air cavity dimensions, to adjust the resonant frequencies to cancel acoustic waves of different frequencies corresponding to noise, which can change over time. The unit cells can be distributed as part of a metasurface, which can be positioned proximate to a noise source to phase cancel the noise.

### BACKGROUND

Acoustic absorbers are specialized materials or structures designed to mitigate the effects of sound reflections, echoes, and reverberations in various environments. These absorbers function by capturing sound waves and converting their energy into heat, effectively reducing the intensity of the sound waves and preventing them from bouncing off surfaces and causing unwanted sound reflections. They are typically engineered using porous materials with intricate structures that allow sound waves to penetrate deep into the material, where the acoustic energy is dissipated as thermal energy through friction and air resistance.

Existing acoustic absorbers come in various forms, including foam panels, fabric-wrapped panels, diffusers, bass traps, and more. One of the problems with existing acoustic absorbers is that they are not desirable in certain heat-sensitive environments. For example, servers generate a lot of heat and thus are designed with fans to cool dissipate the heat; however, fans can generate a lot of annoying noise. Using existing acoustic absorbers to absorb server noise reduces the noise, but can significantly reduce dissipation of the heat generated by servers, which can result in high heat levels that can reduce server performance and possibly cause a server to shut down to avoid damage from overheating.

### BRIEF DESCRIPTION OF THE DRAWINGS

The technology described herein is illustrated by way of example and not limited in the accompanying figures in which like reference numerals indicate similar elements and in which:

FIG. 1A is a block diagram showing an example system for implementing a metasurface with microelectromechanical systems (MEMS) actuators in resonating unit cells for noise cancellation by phase canceling a narrowband frequency in acoustic waves, in accordance with various example embodiments and implementations of the subject disclosure.

FIG. 1B is a representation of an example metasurface deployed for noise cancellation, including a resonator with a MEMS actuator for varying the resonance frequency, in accordance with various example embodiments and implementations of the subject disclosure.

FIG. 2A is a two-dimensional side view representation of example unit-cells including one enlarged unit cell showing various dimensions that determine, in part, the unit cell's resonance frequency, in accordance with various example embodiments and implementations of the subject disclosure.

FIG. 2B is a graphical representation of resulting absorption coefficient values of the unit-cell(s) of FIG. 2A over a range of frequencies, including a very high absorption coefficient value at the designed frequency 1310 Hz, in accordance with various example embodiments and implementations of the subject disclosure.

FIG. 3 is a side view representation of an example noise canceling Helmholtz resonator that includes a MEMS actuator for varying the resonance frequency by moving a floor partition in the resonator's chamber, in accordance with various example embodiments and implementations of the subject disclosure.

FIG. 4A is a side view representation of an example noise canceling Helmholtz resonator that includes a MEMS actuator for varying the resonance frequency by laterally moving a sidewall partition in the resonator's chamber, in accordance with various example embodiments and implementations of the subject disclosure.

FIG. 4B is a top view representation of an example noise canceling Helmholtz resonator that includes a MEMS actuator for varying the resonance frequency by laterally moving a sidewall partition in the resonator's chamber, in accordance with various example embodiments and implementations of the subject disclosure.

FIG. 5 is a two-dimensional side view representation of an example noise canceling Helmholtz resonator that includes a MEMS actuator for varying the resonance frequency by laterally moving a sidewall partition in the resonator's neck port, in accordance with various example embodiments and implementations of the subject disclosure.

FIG. 6 is a side view representation of an example noise canceling Helmholtz resonator that includes a MEMS actuator for varying the resonance frequency by moving a floor partition in the resonator's chamber based on sensor feedback to a controller, in accordance with various example embodiments and implementations of the subject disclosure.

FIGS. 7A and 7B are side view representations of an example MEMS-based actuator highlighting fabrication before and after removal of a sacrificial layer, respectively, in accordance with various example embodiments and implementations of the subject disclosure.

FIG. 7C is a side view representation of an example MEMS-based actuator showing an example in which a cantilever is shown as bent upwards as a result of joule heating, in accordance with various example embodiments and implementations of the subject disclosure.

FIG. 8 is a three-dimensional representation of an example sound absorbing metasurface showing an enlarged view of an example unit cell with variable cavity dimensions, in accordance with various example embodiments and implementations of the subject disclosure.

FIG. 9 is a representation of an example portion of a sound absorbing metasurface showing an enlarged view of two of a metasurface's adjacent, variable cavity unit cells positioned to phase cancel a narrowband frequency within incoming acoustic waves from a server, in accordance with various example embodiments and implementations of the subject disclosure.

FIG. 10 is a representation of an example portion of a sound absorbing metasurface showing an enlarged view of two of a metasurface's adjacent, variable cavity unit cells positioned to phase cancel a narrowband frequency within incoming acoustic waves from a rack of servers, in accordance with various example embodiments and implementations of the subject disclosure.

FIG. 11 is a three-dimensional, perspective representation of an example sound absorbing metasurface composed of unit cells for wrapping around a rack of servers to reduce noise emanating from the servers, in accordance with various example embodiments and implementations of the subject disclosure.

FIG. 12 is a graphical representation showing example reflection coefficient data for frequency versus phase with respect to sound absorption, in accordance with various example embodiments and implementations of the subject disclosure.

FIG. 13 is a flow diagram showing example operations related to controlling a MEMS device to adjust a variable dimension of a Helmholtz resonator unit cell, to resonate the Helmholtz resonator unit cell to cancel acoustic wave noise, in accordance with various example embodiments and implementations of the subject disclosure.

### DETAILED DESCRIPTION

Various embodiments and implementations of the technology described herein are generally directed towards a sound absorbing device based on inverted phase cancellation, and more particularly towards Helmholtz resonators with variable cavity dimensions, and thus adjustable resonant frequencies, as adjusted by a microelectromechanical systems (MEMS) device. The technology described herein facilitates the design and implementation of such unit cells into metasurfaces that can be configured and positioned to efficiently absorb and dissipate sound waves of a specific frequency. Significantly, the use of metasurfaces as described herein do not increase the heat levels of computing devices substantially compared to existing technologies for sound absorption that do not facilitate ventilation/do not dissipate the heat very well. The specific frequency can be of any frequency/narrowband frequency range over a broad range of audible frequencies, or even subsonic (below 20 Hz)/supersonic frequencies (up to about 20,000 Hz).

Reference throughout this specification to “one embodiment,” “an embodiment,” “one implementation,” “an implementation,” etc. means that a particular feature, structure, or characteristic described in connection with the embodiment/implementation is included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations. It also should be noted that terms used herein, such as “optimize,” “optimization,” “optimal,” “optimally” and the like only represent objectives to move towards a more optimal state, rather than necessarily obtaining ideal results. For example, “optimal” placement of a subnet means selecting a more optimal subnet over another option, rather than necessarily achieving an optimal result. Similarly, “maximize” means moving towards a maximal state (e.g., up to some processing capacity limit), not necessarily achieving such a state.

Further, it is to be understood that the present disclosure will be described in terms of a given illustrative architecture; however, other architectures, structures, substrate materials and process features, and steps can be varied within the scope of the present disclosure.

It will also be understood that when an element such as a layer, region or substrate is referred to as being “on” or “over” another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

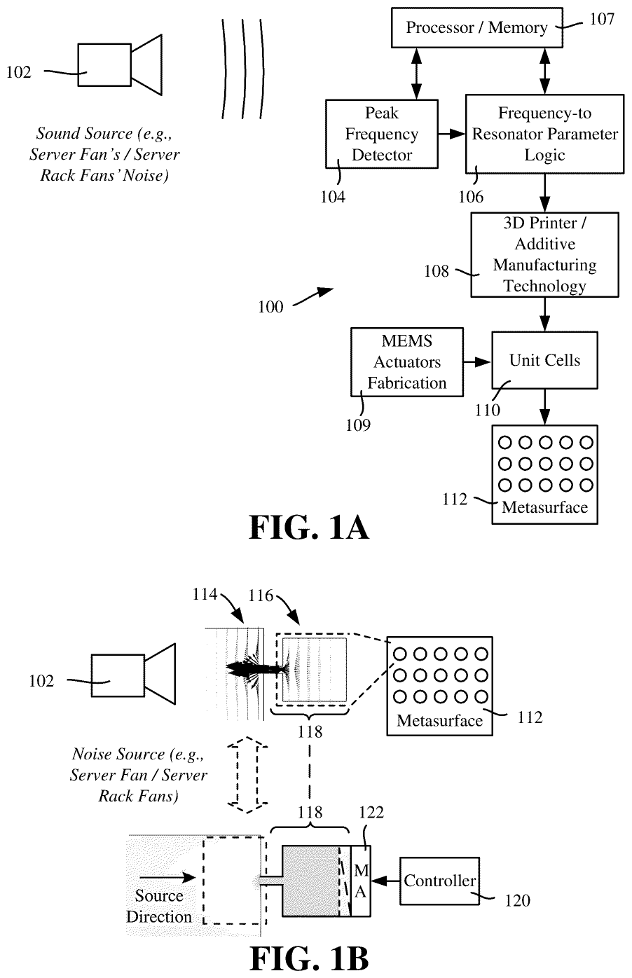

FIG. 1A shows a generalized block diagram of an example system 100 including a sound source 102 such as server fan/fans of a rack of servers that generate undesirable noise including at a frequency that is to be absorbed based on the technology described herein. A frequency measurement tool can be used as a peak frequency detector 104 or the like to determine which approximate narrowband frequency to cancel as described herein. As will be seen, the frequency itself is absorbed extremely efficiently by the technology described herein, with a narrow band of nearby frequencies also reduced to a lesser, but still desirable, extent.

Once the general frequency to cancel is determined, frequency-to resonator parameter logic 106 can be used to determine the parameters of unit cells that can inverse phase cancel that frequency. The parts of the unit cell can be constructed with 3D printer/additive manufacturing technology 108. The MEMS device, described herein, can be 3D printed, or can be separately fabricated (block 109), and, for example, can be incorporated into the unit cell, or positioned at a location that can move a partition in the unit cell. As a more particular example, consider a Helmholtz resonator cavity (e.g., the chamber portion) with a moveable floor that can be raised or lowered, e.g., basically like a piston. The MEMS device can be controlled to adjust the height of the unit cell's chamber, thereby establishing the resonant frequency of the Helmholtz resonator.

The unit cells are based on the principles of Helmholtz resonators, which are acoustic cavities with a small neck port or opening that are highly effective at absorbing specific frequencies via resonance. For example, the resonant frequency (f_{resonance}) of a classical Helmholtz resonator with respect to frequencies in the audible range is determined by:

$${f}_{resonance} = \frac{c}{2 π} \sqrt{\frac{S}{{L}_{p} V}}$$

where c is the speed of sound, S is the neck port cross-sectional area, Lₚ=L_{neck}+1.7r_{neck} (for a cylindrical neck port) and V is the unit cell's cavity chamber's volume.

The unit cells, each represented as a small circle in FIGS. 1A and 1B, are incorporated into a metasurface 112, which can then be positioned to cancel the noise source at the determined frequency. In one implementation, the metasurface 112 contains an array of the unit cell resonator units arranged in a two-dimensional pattern. For absorbing a server's fan noise, for example, the metasurface 112 can be positioned proximate to the server's location, or even wrapped around at least part of the server's housing. The same metasurface noise-cancellation concept can be extended to a rack of servers via appropriately-sized (e.g., larger) and/or more metasurfaces.

As generally represented in FIG. 1B, when incident sound waves (block 114) interact with the metasurface 112, the variable Helmholtz resonators within the array selectively absorb the corresponding frequencies via inverse phase cancellation (represented by vectors in blocks 114 and 116). As sound waves enter the resonators (e.g., the resonator 118) through the neck port, they create pressure fluctuations within the cavities. By engineering the geometrical parameters of the cavity/air chamber, and then adjusting the cavity dimensions as needed (via a controller and MEMS actuator (MA) 122) as described herein, the resulting resonance frequency of the unit cell creates a π phase shift reflected wave with respect to the incident wave as shown in FIG. 1B, where the two sets of waves with opposite phase cancel, effectively absorbing the frequency. This is highlighted via the air velocity vector plot showing the direction of the reflected wave with x phase shift in the upper portion of FIG. 1B. In addition, these pressure fluctuations also cause the air inside the cavities to oscillate, effectively converting acoustic energy into kinetic energy. This kinetic energy is then dissipated as heat through viscous losses in the narrow neck of the resonators, however the heat dissipation is appreciably better relative to traditional sound absorbers and does not significantly affect thermal performance of a server.

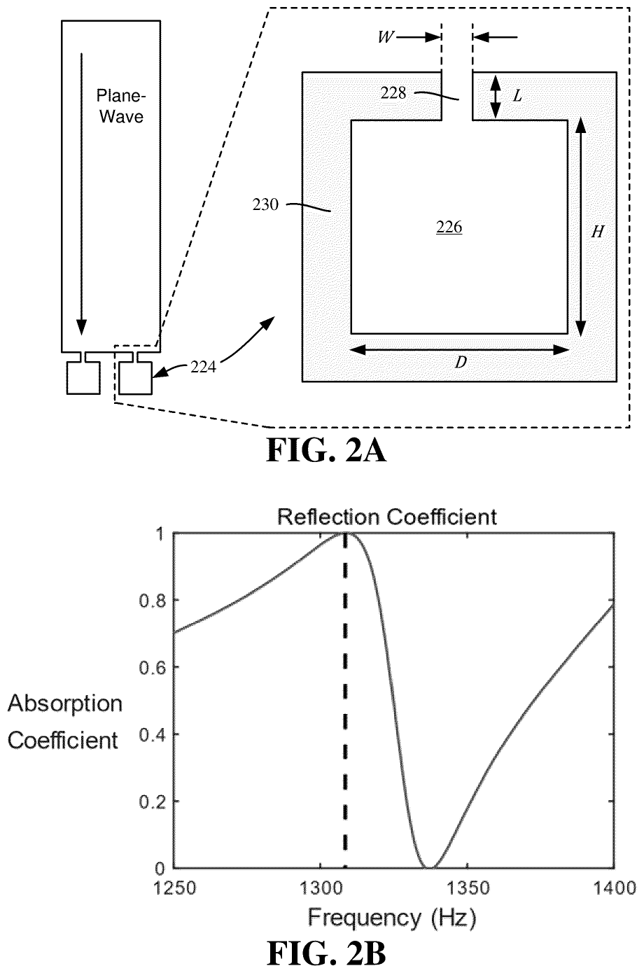

As generally represented in FIG. 2A, each unit cell 224 comprises a cavity, or air chamber 226, often with a neck port 228 that exposes the air chamber to the air/incoming sound waves, with dimensions engineered to target a particular frequency or a narrowband range of frequencies of interest. The dimensions of the air chamber 226 and neck port 228 are designed based on generally desired narrow band of acoustic frequencies to cancel, allowing the unit cells of the metasurface 112 (FIG. 1) to resonate when exposed to sound waves of those frequencies. When constructed, the air chamber 226 and neck port 228, which are hollow to contain air, and have one or more variable dimensions as described herein, are enclosed in a supporting structure 230 through which the neck port 228 extends to couple the chamber to the air propagating the sound wave.

FIG. 2A illustrates the unit cell's dimensions, which are “variable” during initial design before fabrication, and then once constructed and deployed, are controllably variable via MEMS adjustment (not explicitly shown in FIG. 2A) as described herein. The dimensions include the chamber height (H), and in the example of a cylindrical air chamber, the chamber's diameter (D) which is twice the radius, such that a cylindrical air chamber's volume is:

$$V = {( π \times \frac{1}{2} D )}^{2} \times H .$$

The neck port, which is also a cylindrical tube in this example, has an area of

$${( π \times \frac{1}{2} W )}^{2}$$

and a length of L. The unit cell is not limited to cylindrical air chambers or cylindrical necks, but can be of any suitable shape that facilitates resonating at the desired frequency in a manner that phase cancels the incoming sound wave of that frequency.

The result is highly efficient sound absorption at specific frequencies as shown in FIG. 2B, which in this example is around 1310 Hz, making this metasurface particularly useful for targeted noise reduction in environments where controlling specific frequencies is beneficial, such as in architectural acoustics, automotive design, and industrial settings. The dimensions are deep subwavelength values relative to the subwavelength of the incoming wave. For example, one metasurface implementation was designed to inverse phase cancel an incoming frequency 1310 Hz, with selected unit-cell dimensions of D=18 mm, H=16 mm, L=6 mm, W=3.2 mm. The resulting absorption coefficient of the designed unit-cell achieved near-perfect (greater than 98 percent absorption at the designed frequency 1310 Hz), as shown in FIG. 2B. As can be seen from this example, the structure is deeply sub-wavelength; the wavelength λ at 1310 Hz in air is 260 mm, which is controlled by unit-cell with thickness of 22 mm. As can be seen, the above-selected dimensions of D, H, L and W for 1310 hertz (λ=260 m) in air range from about λ/14 to λ/81 (or λ/13 if based on the thickness of 22 mm). Note that while the curve of FIG. 2B shows about seventy percent absorption effectiveness around 1250 Hz increasing to the peak absorption at the desired frequency 1310 Hz, the curve can be flattened more around the designed frequency to an extent, e.g., by slightly tweaking the dimensions of some of the unit cells.

The designed unit-cell only needs air and its surrounding acoustic hard boundaries. This is different from other approaches using porous and fibrous materials and gradient index materials. At this scale the unit-cell acts almost like a point towards the wave, so this design is not straightforward. However, the materials and the compact design in mm-scale/deeply sub-wavelength facilitate fabricating the unit cell as a thin, light-weight, and cost effective absorber with 3D printing technology.

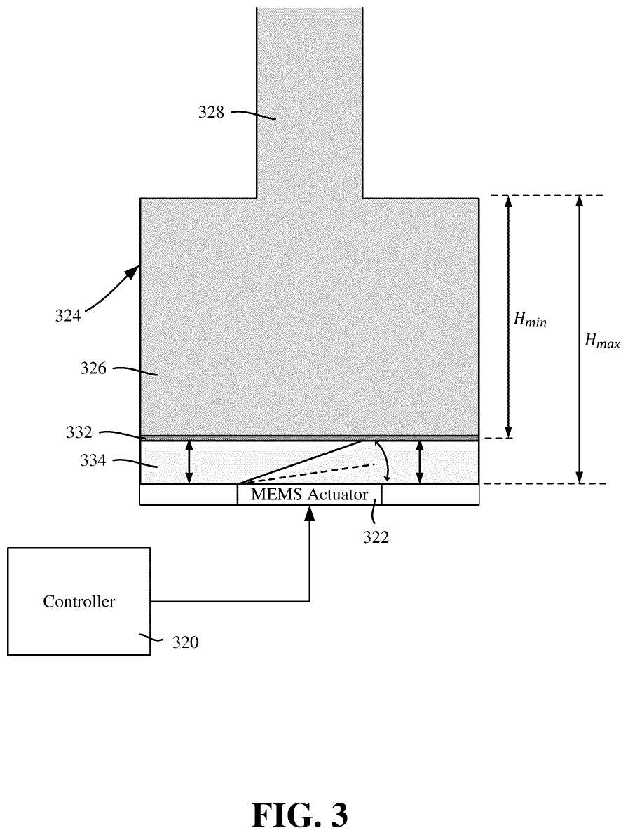

FIG. 3 shows the concept of a Helmholtz resonator 324 with variable resonance, which is based on a MEMS actuator (MA) 322, controlled by a controller 320. As shown in FIG. 3, the example MEMS actuator (MA) 322 is in the form of a cantilever that is physically coupled to move a moveable partition (in this example, a floor 332 of the resonator 324), and thus is able to change the chamber's effective height between some minimum height Hₘᵢₙ and a maximum height Hₘₐₓ, and thus vary the chamber's volume the (darker-shaded) chamber portion labeled 326. Other types of MEMS actuators can be used instead, e.g., a lateral triple-arm device, and/or multiple MEMS actuators can work together to move a single partition. Note that a partition can be constructed as part of the MEMS device, e.g., a MEMS device can be fabricated along with the partition as a single unit.

In general, the MEMS actuator 322 changes the amount of cantilever displacement based on Joule heating, by applying a voltage across separated fixed (anchored) metallic ends of the cantilever 322, in which the metal (that is separated at the anchored end sides) is connected at the free end. The cantilever 322 thus can be in the shape of a penannular ring, U-shaped, V-shaped and so on, as long as voltage can be applied across the separated ends to heat the metal by current flow therethrough.

In the example of FIG. 3, the chamber's variable volume with respect to resonating is the portion labeled 326, which can be varied by control of the amount of MEMS cantilever displacement. The volume of air in the (lightly-shaded) chamber portion labeled 334 (e.g., entering and exiting via one or more vents so that the air pressure is equalized) thus varies as well, but does not significantly affect the resonance of the Helmholtz resonator 322. A gasket or seal can be used if needed, however any slight change in the air pressure in the chamber portion 326 resulting from leaks around the moveable floor 332 likely can be compensated for by slightly adjusting the floor's height.

By way of an example usage scenario, consider a metasurface of such unit cells configured to noise cancel the fan noise emanating from a server. The Helmholtz resonators' resonant frequency can be adjusted as described herein to significantly cancel the noise. Later, consider that the server fan changes its frequency as the server heats up/cools down, or that the server is replaced with a different server having a different fan noise frequency. Adjusting the MEMS actuators operates to cancel the different frequency instead.

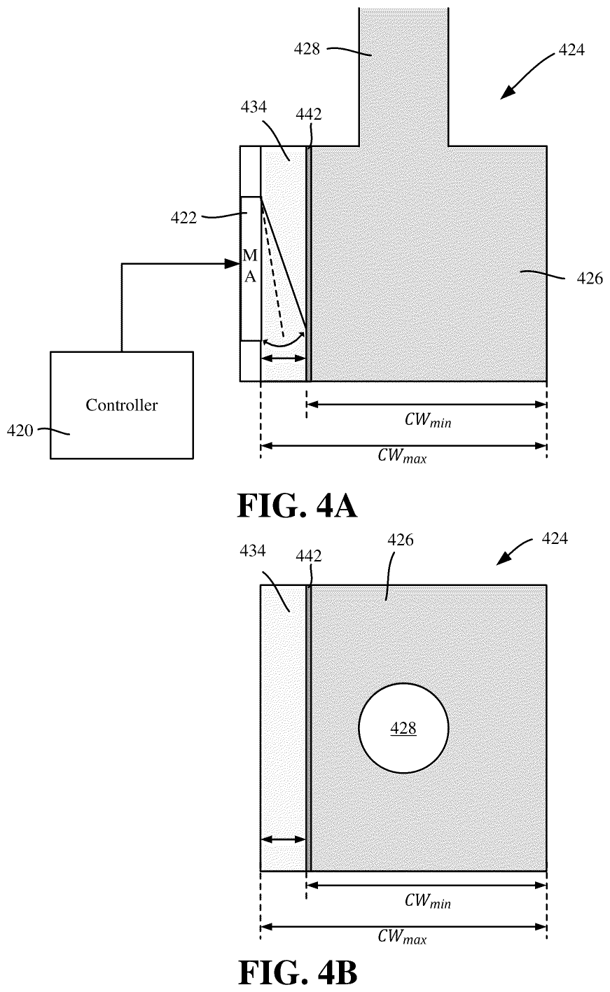

The chamber of a Helmholtz resonator need not be cylindrical, and, for example, can be rectangular such as square. As such, instead of a moveable floor, the moveable partition can be a sidewall 432 (or sidewalls), as shown in FIG. 4A (side view) and 4B (top view). This corresponds to a variable chamber width/volume 428, e.g., by changing between some minimum chamber width CWₘᵢₙ and maximum chamber width CWₘₐₓ. Note that the parts labeled 4xx in FIGS. 4A and 4B correspond to those labeled 3xx in FIG. 3, and are not described again for purposes of brevity. Also note that the MEMS actuator (MA) and controller are not again shown in FIG. 4B.

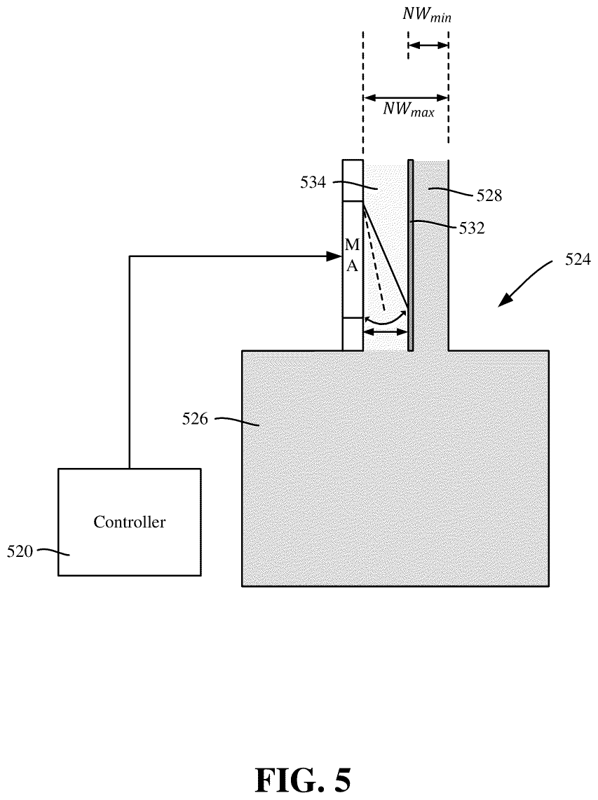

Similarly, the neck port of a Helmholtz resonator need not be cylindrical, and, for example, can be rectangular such as square. As such, instead of (or in addition to) a moveable partition in the chamber, a moveable sidewall 532 partition can be located in the neck port 528, as generally shown in the side view of FIG. 5. This corresponds to a variable neck port width/volume 528, e.g., by changing between some minimum neck port width NWₘᵢₙ and maximum neck port width NWₘₐₓ.

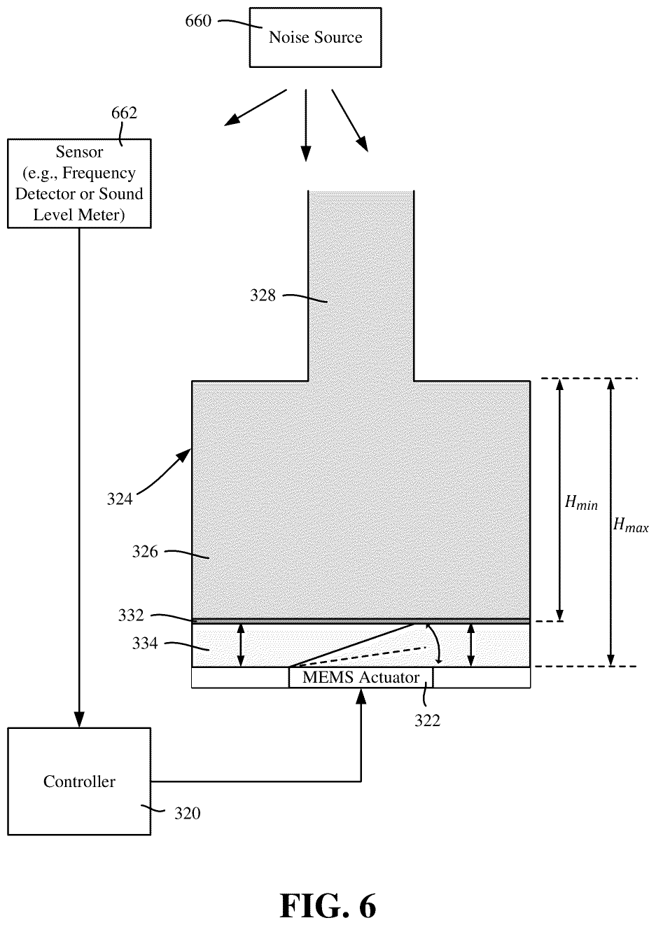

FIG. 6 shows the concept of feedback-based adjustment for noise cancellation, using the variable dimensions resonator 324 of FIG. 3. In general, a noise source 660 such as one or more server fans outputs noise that can be sensed by a sensor 662. For example, a frequency sensor can pick up the main frequency peak of the noise, and communicate this information to the controller 320. The controller can then calculate (or look up/interpolate from previously determined data) the chamber height/volume needed to cancel that frequency, select the corresponding actuator voltage, and adjust the free end of the cantilever of the MEMS actuator 322 accordingly. Another alternative is to sense the noise level, e.g., at some appropriate location or locations, and adjust the MEMS actuator 322 until the lowest amount of noise level results. As the frequency of the acoustic wave (noise) changes, the MEMS actuators can be adjusted to cancel the changed frequency, which can be a reasonably rapid adjustment.

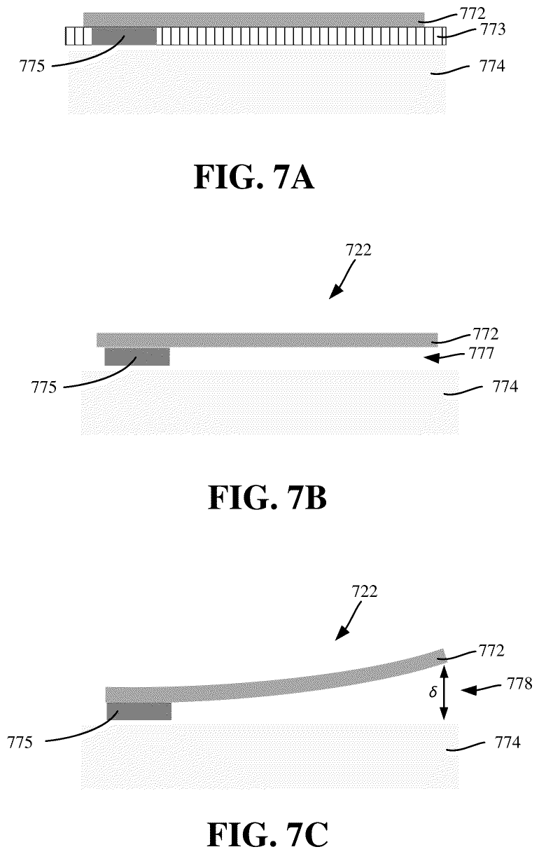

Turning to cantilever-based MEMS actuators, a top metal layer 772 can be made from a thin layer of aluminum (Al), as shown in the fabrication cross-section in FIG. 7A. This facilitates efficient fabrication, as all metallic pattern layers can be the same materials, and/or the same thicknesses. In the layer stack of FIG. 7A, going from top to bottom, the top aluminum layer 772 is on the top of a sacrificial layer 773 of silicon dioxide (SiO₂), which sits on the bottom 774 of the metasurface supporting structure or the like. An anchor layer 775, at the same level as the sacrificial layer 773, can be aluminum or other suitable material. Note that while aluminum is one material, any suitable material can be used.

The sacrificial layer 773 is selectively removed (e.g., by known etching methods) from underneath the top metal layer 772, resulting in a cantilever by leaving an air gap 777 on one side of the cantilever/aluminum layer 772 after release as shown in FIG. 7B. The other side of the aluminum layer 772 remains attached to the bottom 774 of the metasurface supporting structure via the anchor 775 on one end.

Joule heating results in electrothermal actuation, such as to curve the heated aluminum layer 772 upward based on the amount of joule heating, as generally represented in FIG. 7C. Note that the displacement δ increases, as apparent from the larger air gap 778 in the actuated state shown in FIG. 7C, relative to the non-actuated state in FIG. 7B. Although not explicitly shown, it is feasible to have a metallic cantilever that bends downward in response to joule heating, e.g., in an alternative implementation, the cantilever can be angled somewhat upward when non-actuated, and bent downward when subject to joule heating, which also will move a partition.

FIG. 7C thus corresponds to one MEMS cantilever-type actuator in its actuated state, which shows the vertical displacement, 8, of the tip of the cantilever due to thermal expansion from applied voltage/joule heating without any other external forces applied. The vertical displacement δ can be derived from the thermal expansion equation and the bending moment equation.

In another nonlimiting implementation, the top layer can be made from a bimorph material, such as aluminum (Al) and aluminum oxide (Al2O7). When the sacrificial layer is selectively removed from underneath the bimorph layer, a cantilever results by leaving an air gap on one side of the cantilever after release, with the other side of the cantilever remaining anchored. Unlike the aluminum cantilever, due to residual stresses in the fabrication process a bimorph cantilever is curved upwards in the absence of Joule heating, somewhat similar to the side view shown in FIG. 7C. The direction and/or magnitude of the bending depends on factors such as the nature and distribution of residual stress, as well as the dimensions and geometry of the cantilever. When Joule heated, the bimorph actuator cantilever straightens, similar to FIG. 7B. In any event, regardless of whether straight or curved when not actuated, Joule heating of a MEMS cantilever can move a partition and thus vary the air cavity parameters (volume dimensions) of a Helmholtz resonator.

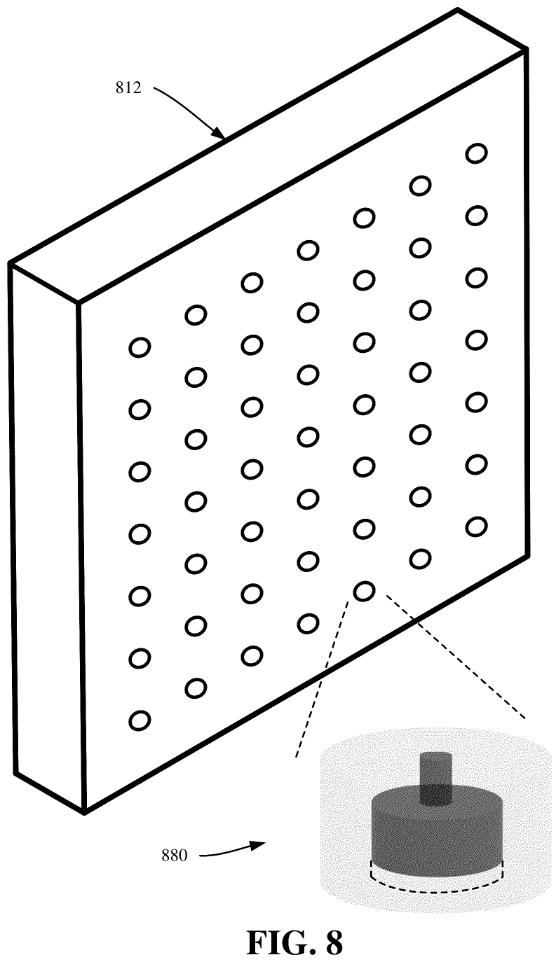

Some or all of the sound absorbing unit cells can be fabricated using 3D printing technology with the features of material simplicity and deeply sub-wavelength compact design. An illustration of an example metasurface 812 with an arrayed distribution of variable volume unit-cells (one of which labeled 880 is enlarged) is shown in FIG. 8.

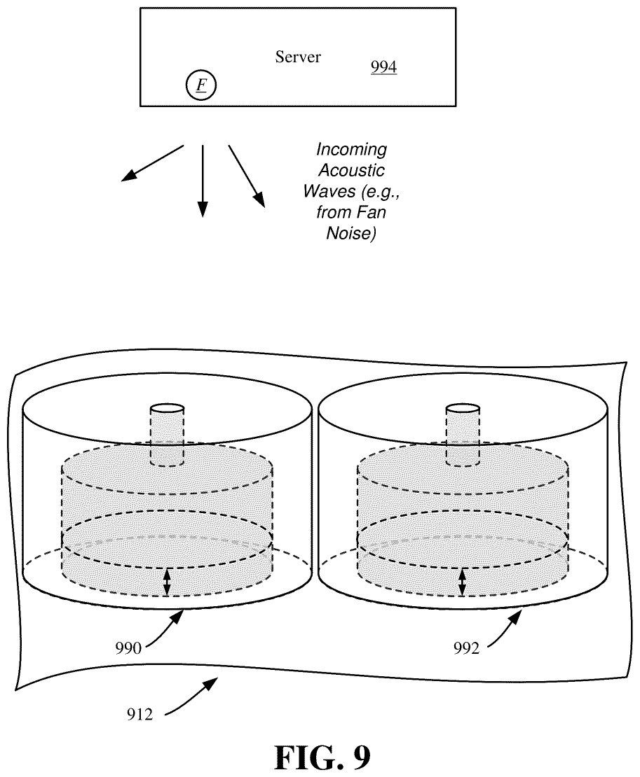

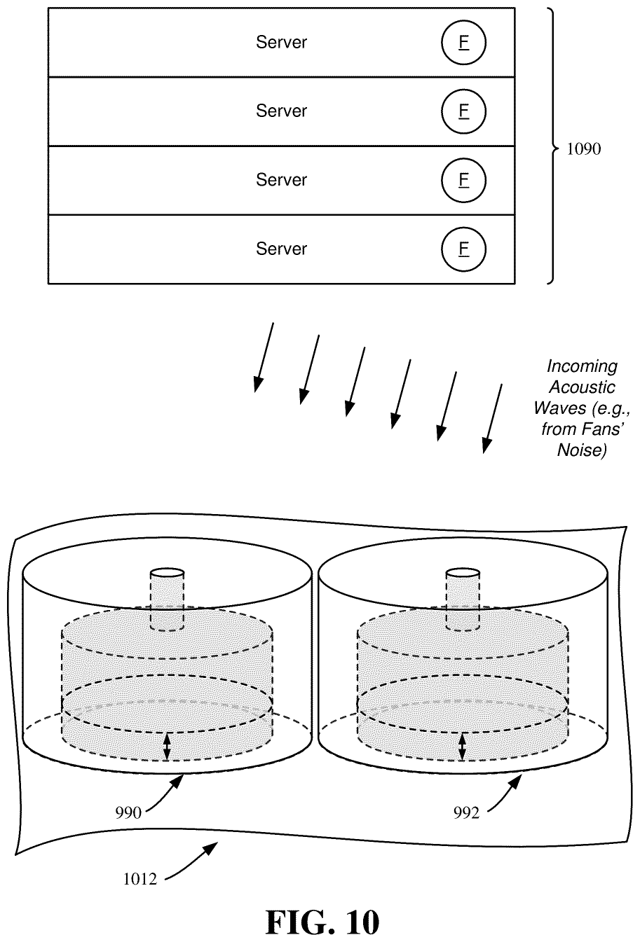

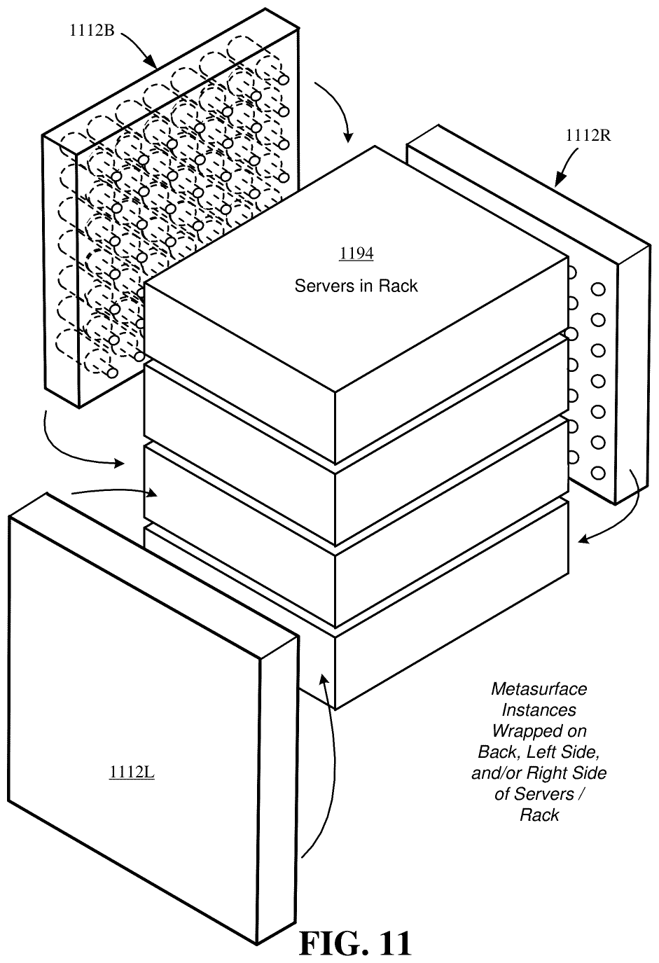

FIG. 9 depicts an example usage scenario, in which a portion of a metasurface 912 is shown with two enlarged moveable-floor type unit cells 990 and 992 positioned proximate a server 994 to cancel noise emanating from the server's fan F. Although not explicitly shown herein, a metasurface or multiple metasurfaces as described herein can be positioned as a noise canceling device proximate a server (FIG. 9) or rack of servers 1094 (FIG. 10), and/or wrapped around at least part of a server or rack of servers 1194 (metasurfaces 1112B, 1112L and 1112R) as depicted in FIG. 11.

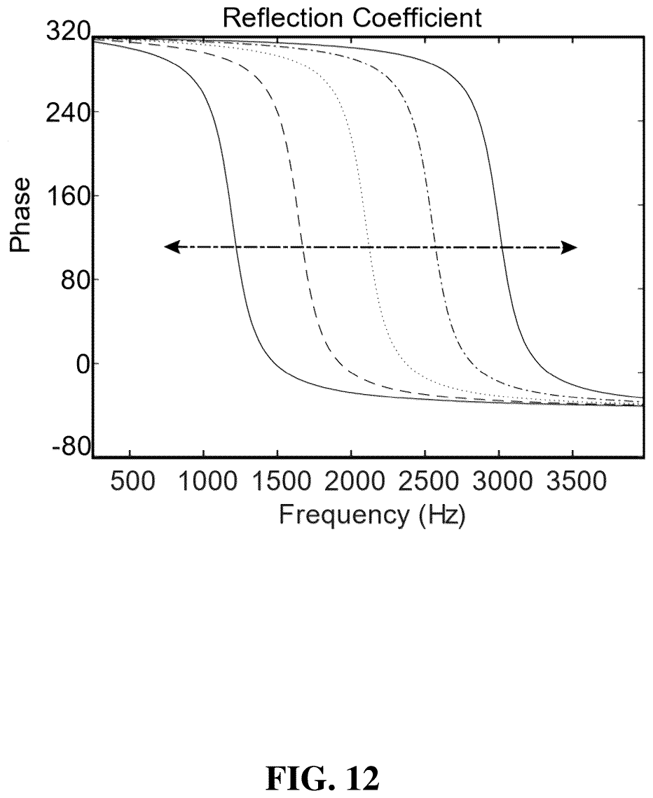

FIG. 12 shows the reflection coefficient resulting from different phases and frequencies. Noise cancellation via the metasurface with adjustable resonant frequency unit cells is thus feasible over a wide range of frequencies.

One or more aspects can be embodied in a system, such as described and represented in the drawing figures herein. The system can include a unit cell of a metasurface configured for sound absorption within a narrowband frequency range. The unit cell can include an air cavity within a supporting structure, in which the air cavity can include a chamber and a neck port. The unit cell further can include a moveable partition within the air cavity that changes at least one of: a first volume of the chamber, or a second volume of the neck port; the first volume and the second volume determine a resonant frequency of the unit cell, to resonate the unit cell at the resonant frequency to phase cancel the incoming acoustic wave, responsive to being exposed to the incoming acoustic wave. The system further can include a microelectromechanical systems (MEMS)-based device physically coupled to the moveable partition, and that, in response to control signaling, moves the moveable partition to determine the resonant frequency of the unit cell.

The moveable partition can be positioned as a chamber floor usable to change the first volume of the chamber by changing a height dimension of the chamber.

The moveable partition can be positioned as a chamber part usable to change the first volume of the chamber by changing a width dimension of the chamber.

The moveable partition can be positioned as a neck port part usable to change the second volume of the neck port by changing a width dimension of the neck port.

The system further can include a controller that applies the control signaling, the control signaling comprising energy that heats the MEMS-based device, to move the moveable partition by a controlled displacement distance. The MEMS-based device can include a bimorph MEMS cantilever comprising an anchored portion and a non-anchored portion, wherein the non-anchored portion can be at an upward angle relative to the non-anchored portion in a non-actuated state as a result of residual stress, and wherein, in an actuated state, an amount of bimorph MEMS cantilever displacement at an end of the non-anchored portion corresponds to the energy to move the non-anchored portion to a less-upward angle relative to the anchored portion to move the moveable partition by the controlled displacement distance. The MEMS-based device can include a MEMS cantilever comprising an anchored portion and a non-anchored portion, wherein the anchored portion can be substantially parallel to the non-anchored portion in a non-actuated state, and wherein, in an actuated state, an amount of MEMS cantilever displacement at an end of the non-anchored portion corresponds to the energy to move the non-anchored portion to an upward angle relative to the anchored portion to move the moveable partition by the controlled displacement distance.

The unit cell can be incorporated into a metasurface that can include an array of unit cells. The metasurface can be positioned proximate to a server, and the incoming acoustic wave at the unit cell can result from operation of a cooling fan of the server. The metasurface can be positioned proximate to a rack of servers, and the incoming acoustic wave at the unit cell can result from operation of cooling fans of the servers.

The metasurface can be wrapped around at least part of a server, and the incoming acoustic wave at the unit cell can result from operation of a cooling fan of the server.

The metasurface can be wrapped around at least part of a rack of servers, and the incoming acoustic wave at the unit cell can result from operation of cooling fans of the servers.

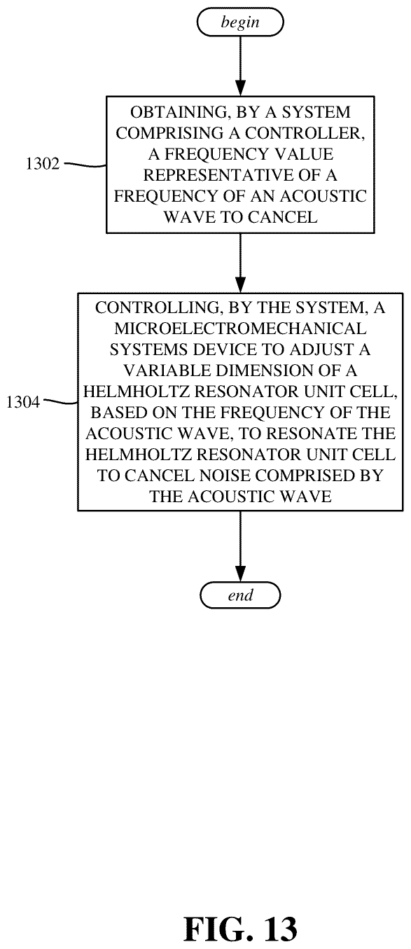

One or more example aspects, such as corresponding to example operations of a method, are represented in FIG. 13. Example operation 1302 represents obtaining, by a system comprising a controller, a frequency value representative of a frequency of an acoustic wave to cancel. Example operation 1304 represents controlling, by the system, a microelectromechanical systems device to adjust a variable dimension of a Helmholtz resonator unit cell, based on the frequency of the acoustic wave, to resonate the Helmholtz resonator unit cell to cancel noise can included by the acoustic wave.

Controlling the microelectromechanical systems device to adjust the variable dimensions can include applying a voltage bias to the microelectromechanical systems device to move a moveable floor of the Helmholtz resonator unit cell by a displacement distance that corresponds to the voltage bias.

Controlling the microelectromechanical systems device to adjust the variable dimensions can include applying a voltage bias to the microelectromechanical systems device to move a moveable structure of the Helmholtz resonator unit cell by a displacement distance that corresponds to the voltage bias.

One or more aspects can be embodied in a metasurface, such as described and represented in the drawing figures herein. The metasurface can include a base structure, and a group of respective unit cells contained by the base structure. The respective unit cells can include respective Helmholtz resonators, which can include respective air chambers coupled to respective neck ports that extend to a surface of the base structure to facilitate air flow to the respective air chambers, and respective microelectromechanical systems devices that are controllable to change respective variable dimensions of the respective Helmholtz resonators. The respective variable dimensions can be adjustable, via the respective microelectromechanical systems devices, to resonate the respective unit cells at respective specific frequency values to collectively phase cancel an incoming acoustic wave when exposed to the incoming acoustic wave.

The respective unit cells can be evenly distributed in an array pattern within the base structure.

The respective unit cells can include respective neck ports and respective air chambers, the respective variable dimensions can include respective variable height dimensions of the respective air chambers, and the respective air chambers can include respective moveable floors that can be adjustable to change the respective height dimensions of the respective air chambers.

The respective unit cells can include respective neck ports and respective air chambers, and the respective unit cells can include moveable structures that can be adjustable to change the respective variable dimensions, the respective variable dimensions comprising at least one of: respective first width dimensions of the respective air chambers, or respective second width dimensions of the respective neck ports.

The metasurface can be configured to collectively phase cancel at least one incoming acoustic wave respectively emanating from at least one server.

As can be seen, the technology described herein facilitates construction and deployment of a metasurface of unit cells having variable dimensions controlled via MEMS actuators, which can be implemented in a practical, compact and lightweight surface configuration. As one example, the metasurface is highly useful in the context of mitigating server noise. One unit-cell design achieved high sound absorption of an incoming sound wave at the frequency for which it was designed and MEMS-adjusted. Based on the technology described herein, thin, light-weight, and cost effective sound absorbers can be constructed, including by using 3D printing and MEMS technology.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a unit cell of a metasurface configured for sound absorption within a narrowband frequency range, the unit cell comprising:
an air cavity within a supporting structure, the air cavity comprising a chamber and a neck port;
a moveable partition within the air cavity that changes at least one of: a first volume of the chamber, or a second volume of the neck port, wherein the first volume and the second volume determine a resonant frequency of the unit cell, to resonate the unit cell at the resonant frequency to phase cancel the incoming acoustic wave, responsive to being exposed to the incoming acoustic wave; and
a microelectromechanical systems (MEMS)-based device physically coupled to the moveable partition, and that, in response to control signaling, moves the moveable partition to determine the resonant frequency of the unit cell.

2. The system of claim 1, wherein the moveable partition is positioned as a chamber floor usable to change the first volume of the chamber by changing a height dimension of the chamber.

3. The system of claim 1, wherein the moveable partition is positioned as a chamber part usable to change the first volume of the chamber by changing a width dimension of the chamber.

4. The system of claim 1, wherein the moveable partition is positioned as a neck port part usable to change the second volume of the neck port by changing a width dimension of the neck port.

5. The system of claim 1, further comprising a controller that applies the control signaling, the control signaling comprising energy that heats the MEMS-based device, to move the moveable partition by a controlled displacement distance.

6. The system of claim 5, wherein the MEMS-based device comprises a bimorph MEMS cantilever comprising an anchored portion and a non-anchored portion, wherein the non-anchored portion is at an upward angle relative to the non-anchored portion in a non-actuated state as a result of residual stress, and wherein, in an actuated state, an amount of bimorph MEMS cantilever displacement at an end of the non-anchored portion corresponds to the energy to move the non-anchored portion to a less-upward angle relative to the anchored portion to move the moveable partition by the controlled displacement distance.

7. The system of claim 5, wherein the MEMS-based device comprises a MEMS cantilever comprising an anchored portion and a non-anchored portion, wherein the anchored portion is substantially parallel to the non-anchored portion in a non-actuated state, and wherein, in an actuated state, an amount of MEMS cantilever displacement at an end of the non-anchored portion corresponds to the energy to move the non-anchored portion to an upward angle relative to the anchored portion to move the moveable partition by the controlled displacement distance.

8. The system of claim 1, wherein the unit cell is incorporated into a metasurface comprising an array of unit cells.

9. The system of claim 8, wherein the metasurface is positioned proximate to a server, and wherein the incoming acoustic wave at the unit cell results from operation of a cooling fan of the server.

10. The system of claim 8, wherein the metasurface is positioned proximate to a rack of servers, and wherein the incoming acoustic wave at the unit cell results from operation of cooling fans of the servers.

11. The system of claim 8, wherein the metasurface is wrapped around at least part of a server, and wherein the incoming acoustic wave at the unit cell results from operation of a cooling fan of the server.

12. The system of claim 8, wherein the metasurface is wrapped around at least part of a rack of servers, and wherein the incoming acoustic wave at the unit cell results from operation of cooling fans of the servers.

13. A method, comprising:
obtaining, by a system comprising a controller, a frequency value representative of a frequency of an acoustic wave to cancel; and
controlling, by the system, a microelectromechanical systems device to adjust a variable dimension of a Helmholtz resonator unit cell, based on the frequency of the acoustic wave, to resonate the Helmholtz resonator unit cell to cancel noise comprised by the acoustic wave.

14. The method of claim 13, wherein the controlling of the microelectromechanical systems device to adjust the variable dimensions comprises applying a voltage bias to the microelectromechanical systems device to move a moveable floor of the Helmholtz resonator unit cell by a displacement distance that corresponds to the voltage bias.

15. The method of claim 13, wherein the controlling of the microelectromechanical systems device to adjust the variable dimensions comprises applying a voltage bias to the microelectromechanical systems device to move a moveable structure of the Helmholtz resonator unit cell by a displacement distance that corresponds to the voltage bias.

16. A metasurface, comprising:
a base structure; and
a group of respective unit cells contained by the base structure,
wherein the respective unit cells comprise respective Helmholtz resonators comprising respective air chambers coupled to respective neck ports that extend to a surface of the base structure to facilitate air flow to the respective air chambers, and respective microelectromechanical systems devices that are controllable to change respective variable dimensions of the respective Helmholtz resonators, and
wherein the respective variable dimensions are adjustable, via the respective microelectromechanical systems devices, to resonate the respective unit cells at respective specific frequency values to collectively phase cancel an incoming acoustic wave when exposed to the incoming acoustic wave.

17. The metasurface of claim 16, wherein the respective unit cells are evenly distributed in an array pattern within the base structure.

18. The metasurface of claim 16, wherein the respective unit cells comprise respective neck ports and respective air chambers, wherein the respective variable dimensions comprise respective variable height dimensions of the respective air chambers, and wherein the respective air chambers comprise respective moveable floors that are adjustable to change the respective height dimensions of the respective air chambers.

19. The metasurface of claim 16, wherein the respective unit cells comprise respective neck ports and respective air chambers, and wherein the respective unit cells comprise moveable structures that are adjustable to change the respective variable dimensions, the respective variable dimensions comprising at least one of: respective first width dimensions of the respective air chambers, or respective second width dimensions of the respective neck ports.

20. The metasurface of claim 16, wherein the metasurface is configured to collectively phase cancel at least one incoming acoustic wave respectively emanating from at least one server.
